(19) United States
(12) Patent Application Publication
(10) Pub. No.: US 2016/0232573 A1
(43) Pub. Date: Aug. 11, 2016

(54) DEVICES AND METHODS FOR ADVERTISING DURING FAST-CHARGING OF MOBILE DEVICES

(71) Applicant: StoreDot Ltd., Herzeliya (IL)

(72) Inventors: Daniel Aronov, Netanya (IL); Doron Myersdorf, Kfar Saba (IL); Vadim Sabayev, Rishon LeZion (IL)

(21) Appl. No.: 14/616,764

(22) Filed: Feb. 9, 2015

(51) Int. Cl. G06Q 30/02; G06Q 30/04; H02J 7/00

(52) U.S. Cl. CPC G06Q 30/0267; H02J 7/0052; G06Q 30/04; H02J 2007/0096

(57) ABSTRACT

The present invention discloses devices and methods for advertising during fast-charging of mobile devices. Methods include the steps of: upon engagement of a mobile device with a fast-charging advertising (FCA) device, operationally connecting with the mobile device in order to determine whether the mobile device is enabled for fast-charging; interfacing with a fast-charging module configured to provide fast-charging capability to an enabled mobile device; and upon determining the mobile device is enabled for fast-charging, activating an FCA capability, wherein the FCA capability includes: providing at least one billing option for a billing selection; offering at least one advertising option for an advertising selection; and upon acceptance of the billing selection and the advertising selection: initiating fast-charging of the mobile device via the fast-charging module; and broadcasting an ad during the fast-charging. Preferably, the FCA device is embodied in the fast-charging module, an FCA station, or an FCA system card.

### FIELD AND BACKGROUND OF THE INVENTION

The present invention relates to devices and methods for advertising during fast-charging of mobile devices.

Modern electronic appliances are becoming ubiquitous for personal as well as business use. It cannot be overstated that with the evolution of such devices, mobility has emerged as a key driver in feature enhancement for technological innovation. Significantly, the advent of modern mobile devices having ever-shorter charging times has led to users being detained at the charging location without leaving the mobile device unattended during charging. For existing devices, charging times on the order of an hour are typical, while newer devices have enabled “fast-charging” capabilities on the order of a few minutes. Such short charging times in turn open up opportunities for utilizing the time that a user is waiting for the device to be charged.

It would be desirable to have devices and methods for advertising during fast-charging of mobile devices. Such devices and methods would, inter alia, take advantage of tangential technological enhancements in mobile devices as mentioned above.

### SUMMARY

It is the purpose of the present invention to provide devices and methods for advertising during fast-charging of mobile devices.

It is noted that the term “exemplary” is used herein to refer to examples of embodiments and/or implementations, and is not meant to necessarily convey a more-desirable use-case. Similarly, the terms “preferred” and “preferably” are used herein to refer to an example out of an assortment of contemplated embodiments and/or implementations, and is not meant to necessarily convey a more-desirable use-case. Therefore, it is understood from the above that “exemplary” and “preferred” may be applied herein to multiple embodiments and/or implementations.

Preferred embodiments of the present invention enable devices and methods for advertising during fast-charging of mobile devices.

Therefore, according to the present invention, there is provided for the first time a method for advertising during fast-charging of mobile devices, the method including the steps of: (a) upon engagement of a mobile device with a fast-charging advertising (FCA) device, operationally connecting with the mobile device in order to determine whether the mobile device is enabled for fast-charging; (b) interfacing with a fast-charging module configured to provide fast-charging capability to an enabled mobile device; and (c) upon determining the mobile device is enabled for fast-charging, activating an FCA capability, wherein the FCA capability includes: (i) providing at least one billing option for a billing selection; (ii) offering at least one advertising option for an advertising selection; and (iii) upon acceptance of the billing selection and the advertising selection: (A) initiating fast-charging of the mobile device via the fast-charging module; and (B) broadcasting an ad during the fast-charging.

Preferably, the mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

Preferably, the FCA device is embodied in at least one device selected from the group consisting of: the fast-charging module, an FCA station, and an FCA system card.

Preferably, the step of providing and the step of offering are performed, at least in part, remotely on at least one portal selected from the group consisting of: an FCA portal, an ad portal, and a billing portal.

Preferably, at least one billing option is selected from the group consisting of: a free fast-charging option during the step of broadcasting, a paid fast-charging option during the step of broadcasting, a paid fast-charging option during exemption from the step of broadcasting, and a regular-charging option for an allotted charging duration during the step of broadcasting, an online payment, a direct payment, a credit card payment, a third-party payment, an installment payment, and a prepaid FCA account debit.

Preferably, the advertising selection is based on at least one criterion selected from the group consisting of: an advertiser purchase, a user profile, user-specific usage-data from data-analytics portals, a geographic location of the FCA device, a business location of the FCA device, an FCA-device owner preference, a user-specific location-data history, weather data, an FCA user-preference profile, a category selection, and a selection group.

Preferably, the step of broadcasting is performed on at least one device selected from the group consisting of: the mobile device, the FCA device, a secondary display device, a secondary audio component.

Preferably, the step of broadcasting is performed by at least one operation selected from the group consisting of: transmitting the ad via a direct or indirect network download, delivering the ad from the FCA device, and retrieving the ad from a pre-cached storage location.

Preferably, the method further includes the step of: (d) prior to the step of activating, securing all operations and all data associated with the FCA device.

Preferably, the method further includes the step of: (d) prior to the step of broadcasting, checking for at least one ad update.

According to the present invention, there is provided for the first time a fast-charging advertising (FCA) device for advertising during fast-charging of mobile devices, the FCA device including: (a) a CPU for performing computational operations; (b) a memory module for storing data; (c) a connectivity module for operationally connecting to a network via a communication capability; (d) a billing module configured for providing at least one billing option for a billing selection; (e) an advertising module configured for offering at least one advertising option for an advertising selection; and (f) an interface module configured for: (i) upon engagement of a mobile device with the FCA device, operationally connecting with the mobile device in order to determine whether the mobile device is enabled for fast-charging; (ii) interfacing with a fast-charging module configured to provide fast-charging capability to an enabled mobile device; and (iii) upon determining the mobile device is enabled for fast-charging, activating an FCA capability, wherein the FCA capability is configured for: (A) upon acceptance of the billing selection and the advertising selection, initiating fast-charging of the mobile device via the fast-charging module; and (B) upon acceptance of the billing selection and the advertising selection, broadcasting an ad during the fast-charging.

Preferably, the mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

Preferably, the CPU, the memory module, the connectivity module, the billing module, the advertising module, and the interface module are embodied, at least in part, in at least one device selected from the group consisting of: the fast-charging module, an FCA station, and an FCA system card.

Preferably, the providing and the offering are performed, at least in part, remotely on at least one portal selected from the group consisting of: an FCA portal, an ad portal, and a billing portal.

Preferably, at least one billing option is selected from the group consisting of: a free fast-charging option during the broadcasting, a paid fast-charging option during the broadcasting, a paid fast-charging option during exemption from the broadcasting, and a regular-charging option for an allotted charging duration during the broadcasting, an online payment, a direct payment, a credit card payment, a third-party payment, an installment payment, and a prepaid FCA account debit.

Preferably, the advertising selection is based on at least one criterion selected from the group consisting of: an advertiser purchase, a user profile, user-specific usage-data from data-analytics portals, a geographic location of the FCA device, a business location of the FCA device, an FCA-device owner preference, a user-specific location-data history, weather data, an FCA user-preference profile, a category selection, and a selection group.

Preferably, the broadcasting is performed on at least one device selected from the group consisting of: the mobile device, the FCA device, a secondary display device, a secondary audio component.

Preferably, the broadcasting is performed by at least one operation selected from the group consisting of: transmitting the ad via a direct or indirect network download, delivering the ad from the FCA device, and retrieving the ad from a pre-cached storage location.

Preferably, the FCA device further includes: (g) a security module configured for securing all operations and all data associated with the FCA device.

Preferably, the FCA capability is further configured for: (C) prior to the broadcasting, checking for at least one ad update.

Preferably, the billing module, the advertising module, and the interface module are embodied, at least in part, in the memory module.

According to the present invention, there is provided for the first time a method for doing business, the method including the steps of: (a) configuring a fast-charging advertising (FCA) device for: (i) upon engagement of a mobile device with, operationally connecting with the mobile device in order to determine whether the mobile device is enabled for fast-charging; (ii) interfacing with a fast-charging module configured to provide fast-charging capability to an enabled mobile device; and (iii) upon determining the mobile device is enabled for fast-charging, activating an FCA capability, wherein the FCA capability includes: (A) providing at least one billing option for a billing selection; (B) giving at least one advertising option for an advertising selection; and (C) upon acceptance of the billing selection and the advertising selection: (I) initiating fast-charging of the mobile device via the fast-charging module; and (II) broadcasting an ad during the fast-charging; and (b) offering the initiating for sale.

Preferably, the providing and the giving are performed, at least in part, remotely on at least one portal selected from the group consisting of: an FCA portal, an ad portal, and a billing portal.

Preferably, at least one billing option is selected from the group consisting of: a free fast-charging option during the broadcasting, a paid fast-charging option during the broadcasting, a paid fast-charging option during exemption from the broadcasting, and a regular-charging option for an allotted charging duration during the broadcasting, an online payment, a direct payment, a credit card payment, a third-party payment, an installment payment, and a prepaid FCA account debit.

Preferably, the advertising selection is based on at least one criterion selected from the group consisting of: an advertiser purchase, a user profile, user-specific usage-data from data-analytics portals, a geographic location of the FCA device, a business location of the FCA device, an FCA-device owner preference, a user-specific location-data history, weather data, an FCA user-preference profile, a category selection, and a selection group.

According to the present invention, there is provided for the first time a method for doing business, the method including the steps of: (a) configuring a fast-charging advertising (FCA) device for: (i) upon engagement of a mobile device with, operationally connecting with the mobile device in order to determine whether the mobile device is enabled for fast-charging; (ii) interfacing with a fast-charging module configured to provide fast-charging capability to an enabled mobile device; and (iii) upon determining the mobile device is enabled for fast-charging, activating an FCA capability, wherein the FCA capability includes: (A) providing at least one billing option for a billing selection; (B) giving at least one advertising option for an advertising selection; and (C) upon acceptance of the billing selection and the advertising selection: (I) initiating fast-charging of the mobile device via the fast-charging module; and (II) broadcasting an ad during the fast-charging; and (b) offering the broadcasting for sale.

Preferably, the providing and the giving are performed, at least in part, remotely on at least one portal selected from the group consisting of: an FCA portal, an ad portal, and a billing portal.

Preferably, at least one billing option is selected from the group consisting of: a free fast-charging option during the broadcasting, a paid fast-charging option during the broadcasting, a paid fast-charging option during exemption from the broadcasting, and a regular-charging option for an allotted charging duration during the broadcasting, an online payment, a direct payment, a credit card payment, a third-party payment, an installment payment, and a prepaid FCA account debit.

Preferably, the advertising selection is based on at least one criterion selected from the group consisting of: an advertiser purchase, a user profile, user-specific usage-data from data-analytics portals, a geographic location of the FCA device, a business location of the FCA device, an FCA-device owner preference, a user-specific location-data history, weather data, an FCA user-preference profile, a category selection, and a selection group.

According to the present invention, there is provided for the first time a non-transitory computer-readable medium, having computer-readable code embodied on the non-transitory computer-readable medium, the computer-readable code having program code for advertising during fast-charging of mobile devices, the computer-readable code including: (a) program code for, upon engagement of a mobile device with a fast-charging advertising (FCA) device, operationally connecting with the mobile device in order to determine whether the mobile device is enabled for fast-charging; (b) program code for interfacing with a fast-charging module configured to provide fast-charging capability to an enabled mobile device; and (c) program code for, upon determining the mobile device is enabled for fast-charging, activating an FCA capability, wherein the FCA capability includes: (i) program code for, providing at least one billing option for a billing selection; (ii) program code for, offering at least one advertising option for an advertising selection; and (iii) program code for, upon acceptance of the billing selection and the advertising selection: (A) initiating fast-charging of the mobile device via the fast-charging module; and (B) broadcasting an ad during the fast-charging.

Preferably, the mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

Preferably, the FCA device is embodied in at least one device selected from the group consisting of: the fast-charging module, an FCA station, and an FCA system card.

Preferably, the providing and the offering are performed, at least in part, remotely on at least one portal selected from the group consisting of: an FCA portal, an ad portal, and a billing portal.

Preferably, at least one billing option is selected from the group consisting of: a free fast-charging option during the broadcasting, a paid fast-charging option during the broadcasting, a paid fast-charging option during exemption from the broadcasting, and a regular-charging option for an allotted charging duration during the broadcasting, an online payment, a direct payment, a credit card payment, a third-party payment, an installment payment, and a prepaid FCA account debit.

Preferably, the advertising selection is based on at least one criterion selected from the group consisting of: an advertiser purchase, a user profile, user-specific usage-data from data-analytics portals, a geographic location of the FCA device, a business location of the FCA device, an FCA-device owner preference, a user-specific location-data history, weather data, an FCA user-preference profile, a category selection, and a selection group.

Preferably, the broadcasting is performed on at least one device selected from the group consisting of: the mobile device, the FCA device, a secondary display device, a secondary audio component.

Preferably, the broadcasting is performed by at least one operation selected from the group consisting of: transmitting the ad via a direct or indirect network download, delivering the ad from the FCA device, and retrieving the ad from a pre-cached storage location.

Preferably, the computer-readable code comprising further includes: (d) program code for, prior to the activating, securing all operations and all data associated with the FCA device.

Preferably, the computer-readable code comprising further includes: (d) program code for, prior to the broadcasting, checking for at least one ad update.

These and further embodiments will be apparent from the detailed description that follows.

### BRIEF DESCRIPTION OF THE DRAWINGS

The present invention is herein described, by way of example only, with reference to the accompanying drawings, wherein:

FIG. 1 is a simplified high-level schematic diagram of the system architecture for a fast-charging advertising device for advertising during fast-charging of mobile devices, according to preferred embodiments of the present invention;

FIG. 2 is a simplified top view of an exemplary fast-charging advertising station engaged with an exemplary mobile device, according to preferred embodiments of the present invention;

FIG. 3 is a simplified top view of an exemplary fast-charging advertising system card and the system card engaged with various exemplary devices, according to alternate embodiments of the present invention;

FIG. 4 is a simplified flowchart of the major process steps for advertising during fast-charging of mobile devices, according to preferred embodiments of the present invention.

### DESCRIPTION OF THE PREFERRED EMBODIMENTS

The present invention relates to devices and methods for advertising during fast-charging of mobile devices. The principles and operation for providing such devices and methods, according to the present invention, may be better understood with reference to the accompanying description and the drawings.

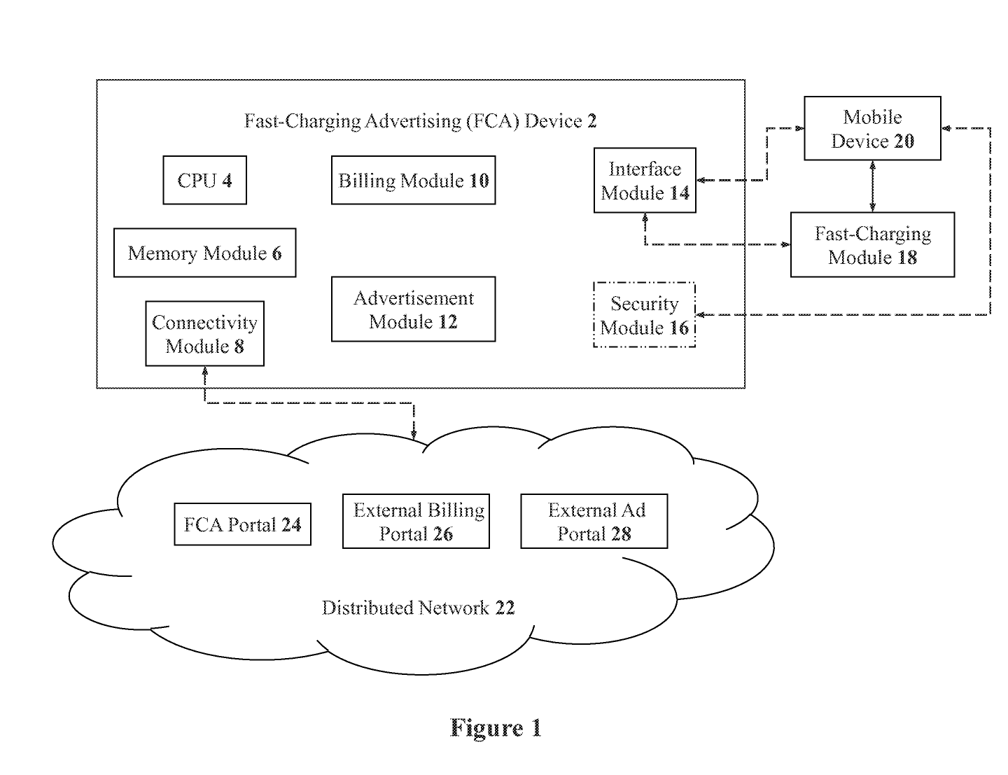

Referring to the drawings, FIG. 1 is a simplified high-level schematic diagram of the system architecture for a fast-charging advertising device for advertising during fast-charging of mobile devices, according to preferred embodiments of the present invention. A fast-charging advertising (FCA) device 2 is shown having a CPU 4, a memory module 6, a connectivity module 8, a billing module 10, an advertisement module 12, and an interface module 14. Optionally, FCA device 2 includes a security module 16 for securing all FCA device operations and data.

Interface module 14 is configured to be operationally connected to a fast-charging module 18 and a mobile device 20 for providing fast-charging detection and capability during ad broadcast and charging. Advanced, state-of-the-art technology provides enablement for such fast-charging detection and capability as disclosed in co-pending patent applications by Aronov et al.

Connectivity module 8 is configured to be operationally connected to a distributed network 22 (e.g., a cloud-computing environment such as the Internet) for exchanging data with an FCA portal 24. FCA device 2 may exchange data via APIs (Application Programming Interfaces) with an external billing portal 26 (e.g., PayPal) and an external ad portal 28 (e.g., individual advertisers, advertising alliances, ad networks, and/or usage-data analytics portals) directly via distributed network 22 and/or indirectly via FCA portal 24.

It is noted that no relative dimensions are implied in the system architecture of FIG. 1. Furthermore, billing module 10, advertisement module 12, and interface module 14 may be located in whole or in part on memory module 6 and/or FCA portal 24, and may be implemented on FCA device 2 in whole or in part in software, firmware, and/or hardware components. Moreover, fast-charging module 18 may include integrated software, firmware, and/or hardware components (e.g., controllers, electrical circuitry, and connectors).

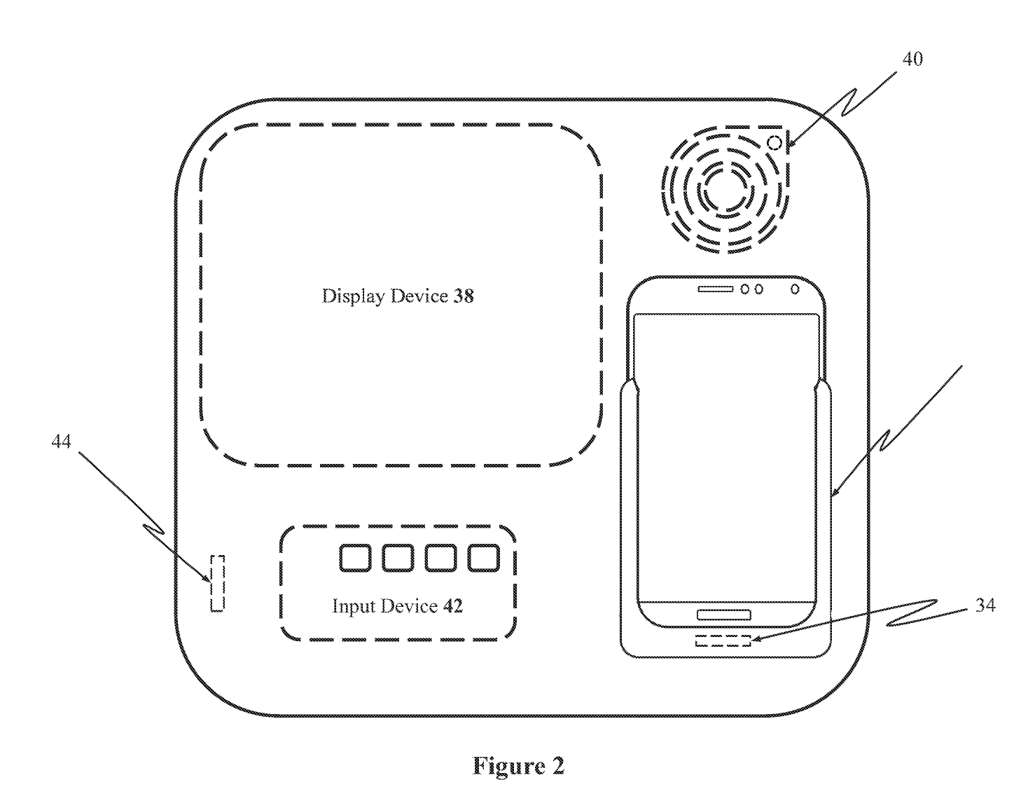

FIG. 2 is a simplified top view of an exemplary fast-charging advertising station engaged with an exemplary mobile device, according to preferred embodiments of the present invention. An exemplary FCA station 30 is shown having a receiving-area holder of a fast-charging module 32. Fast-charging module 32 may optionally include an FCA slot 34 for operationally connecting an FCA system card according to alternate embodiments of the present invention. Fast-charging module 32 is configured for securely engaging a charge-receiving device, such as an exemplary mobile device 36. Fast-charging module 32 may be co-located on FCA station 30 or may be located in the vicinity of FCA station 30.

FCA station 30 may optionally include a display device 38, an audio component 40 (e.g., a speaker and/or microphone) an input device 42 (e.g., a keypad and/or a touchpad), and an FCA slot 44 for operationally connecting an FCA system card according to alternate embodiments of the present invention. Display device 38, audio component 40, and input device 42 may optionally be located in the vicinity of, and operationally connected to, FCA station 30 without being physically attached to FCA station 30.

Furthermore, a secondary display device and/or audio component (not shown) may optionally be located in the vicinity of, and operationally connected to, FCA station 30 as an alternate option for ad broadcast. As intended herein, the term “broadcast” is used to refer to any form of advertisement type (e.g., an ad display image(s), an ad video, and/or an ad audio) and advertisement placement (e.g., displayed and/or played locally on a mobile-device, on an FCA station, and/or on an external audio/video component in the FCA-station vicinity). Moreover, the “broadcast” operation (i.e., “broadcasting” the ad) includes transmitting the ad via a direct or indirect network download, delivering the ad from the FCA device, or retrieving the ad from a pre-cached storage location (e.g., a database on the mobile device).

FCA station 30 further includes all the system componentry shown in FCA device 2 of FIG. 1. Implementations of FCA station 30 in typical use cases include installations at: bus and train stations, public buildings and parks, private lobbies, malls, university campuses, as well as restaurant and business checkout counters.

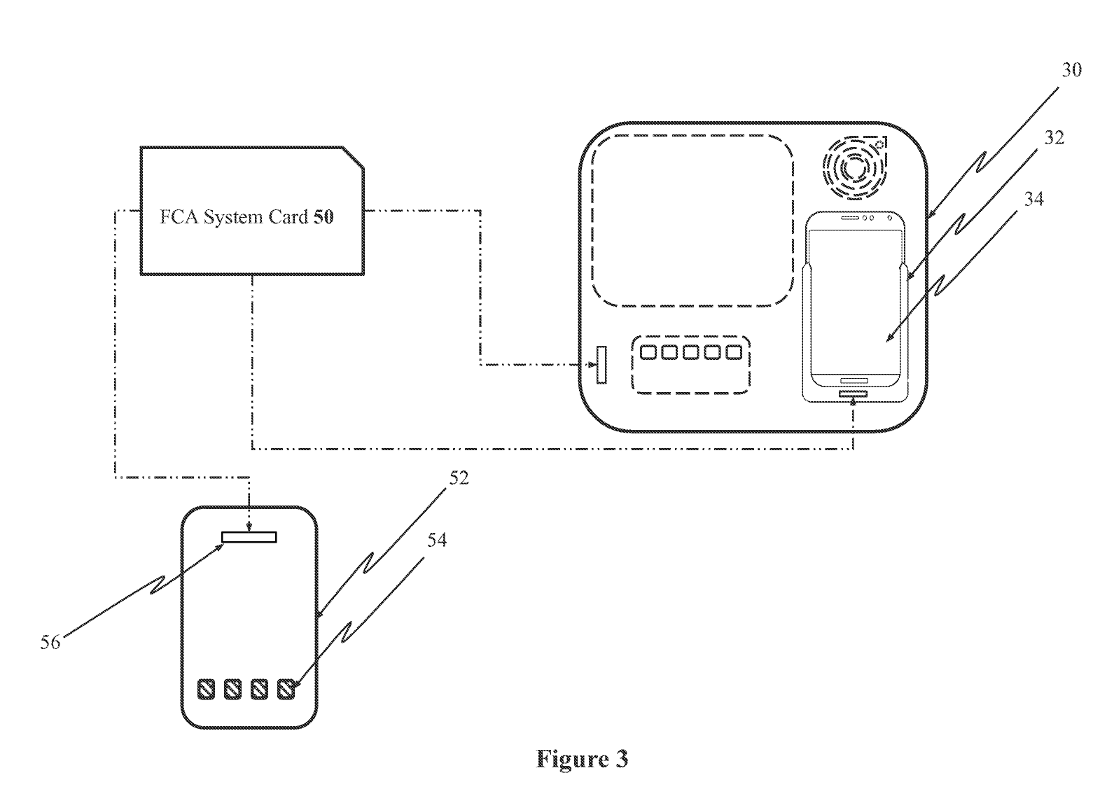

FIG. 3 is a simplified top view of an exemplary fast-charging advertising system card and the system card engaged with various exemplary devices, according to alternate embodiments of the present invention. An exemplary FCA system card 50 is shown having an exemplary micro-card form factor (e.g., a system-on-chip or SOC). FCA system card 50 includes all the system componentry shown in FCA device 2 of FIG. 1. As schematically represented in FIG. 3, FCA system card 50 is configured to be operationally engaged with FCA slots in FCA station 30, fast-charging module 32, and an exemplary fast-charging battery module 52 having fast-charging connectors 54 and an FCA slot 56.

The connectivity module (not shown in FIG. 3) of FCA system card 50 may be configured to operationally connect to a distributed network, as described above with regard to FIG. 1, either directly or by operationally connecting to a communication capability integrated in FCA charging station 30, fast-charging module 32, or mobile device 34 when operationally engaged.

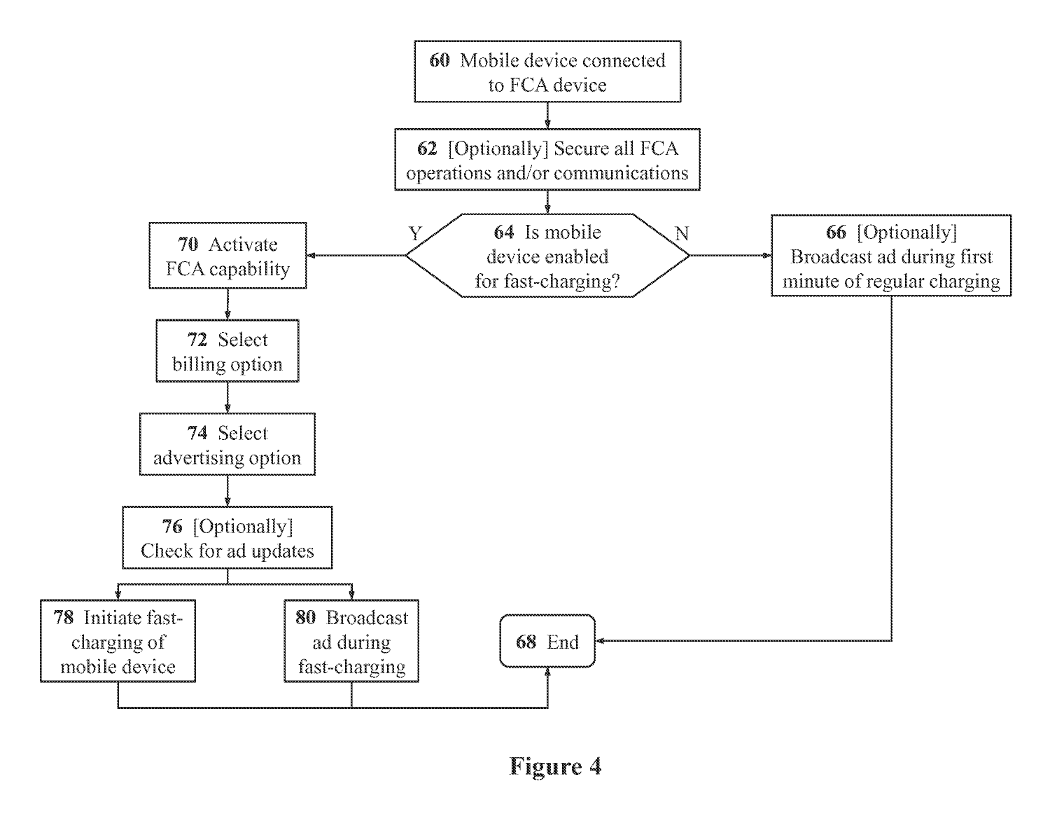

FIG. 4 is a simplified flowchart of the major process steps for advertising during fast-charging of mobile devices, according to preferred embodiments of the present invention. The process starts when a mobile device is operationally connected to an FCA device in order to charge the mobile device (Step 60). The mobile device to be charged may include charge-receiving devices such as: a smartphone, a tablet computer, a hand-held electronic device, a wearable electronic device, and a peripheral device having an integral battery. Such peripheral devices may include: a slave battery (i.e., primarily a charge-delivering device), an external flash component, an external camera component, an external audio component, and an external display component. As intended herein, the term “charged” is used to refer to a full charge of a mobile device. The term “not charged” is used to refer to any charge state other than a full charge of a mobile device.

Optionally, the FCA system secures all FCA operations and/or communications (Step 62). The FCA system then determines whether the mobile device is enabled for fast-charging by detecting the type of battery in the mobile device, only fast-charging mobile devices can be enabled for fast-charging (Step 64). Upon engagement with the FCA device, an FCA client application is activated on the mobile device in order to: (1) allow access to the FCA device, and (2) provide the user with FCA billing and advertisement options. Such an FCA client application may be located either in the mobile-device memory, in an independent memory component of the fast-charging battery installed in the mobile device, or in an FCA system card.

If the mobile device is not enabled for fast-charging, then the FCA system may optionally broadcast an advertisement during the first minute of regular (i.e., conventional and typically slow) charging (Step 66), and the process ends (Step 68). If the mobile device doesn't have the necessary hardware and software for fast-charging, then the FCA capability is not activated, and the FCA system switches to slow-charging mode.

If the mobile device is enabled for fast-charging in Step 64, then the FCA system activates the FCA capability (Step 70). The user of the mobile device then selects a billing option (Step 72). Billing options may include: free fast-charging during advertisement broadcasting, paid fast-charging with or without advertisement broadcasting, and regular charging during the first minute of advertisement broadcasting, online payment, direct payment, credit card payment, third-party payment, installment payment, prepaid FCA account debit. The specific type of billing options is defined by the FCA system at the time that the FCA capability is activated in Step 70.

The user then selects an advertising option (Step 74). Advertisements may be selected automatically by the FCA system based on various criteria including: an advertiser purchase, a user profile, user-specific usage-data (e.g., web search history) from data-analytics portals (e.g., Google Analytics), geographic location of the FCA device, business location of the FCA device (e.g., a branded store), an FCA-device owner preference, a user-specific location-data history, and/or weather data. Advertisements may also be selected by the user based on various options including: an FCA user-preference profile, a category selection (e.g., men's clothing, sports, cooking, and name brands), and/or a selection group (e.g., choosing one ad from three choices). The specific type of advertising option may be defined by the FCA system at the time that the FCA capability is activated in Step 70.

Optionally, the FCA system then may check for advertisement updates (Step 76). The FCA system then initiates fast-charging of the mobile device (Step 78), while also broadcasting the advertisement during the fast-charging process (Step 80). As mentioned above, the ad broadcast may occur on the mobile device, the FCA device, a secondary display device and/or audio component (in the vicinity of, and operationally connected to, the FCA device), or any combination thereof. Ad broadcast to the mobile device may occur via the FCA device, or via the FCA portal. Ad broadcast continues until the mobile device is disconnected from the FCA device, and the process ends (Step 68).

While the present invention has been described with respect to a limited number of embodiments, it will be appreciated that many variations, modifications, and other applications of the present invention may be made.

What is claimed is:

1. A method for advertising during fast-charging of mobile devices, the method comprising the steps of:
(a) upon engagement of a mobile device with a fast-charging advertising (FCA) device, operationally connecting with said mobile device in order to determine whether said mobile device is enabled for fast-charging;
(b) interfacing with a fast-charging module configured to provide fast-charging capability to an enabled mobile device; and
(c) upon determining said mobile device is enabled for fast-charging, activating an FCA capability, wherein said FCA capability includes:
(i) providing at least one billing option for a billing selection;
(ii) offering at least one advertising option for an advertising selection; and
(iii) upon acceptance of said billing selection and said advertising selection:
(A) initiating fast-charging of said mobile device via said fast-charging module; and
(B) broadcasting an ad during said fast-charging.

2. The method of claim 1, wherein said mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

3. The method of claim 1, wherein said FCA device is embodied in at least one device selected from the group consisting of: said fast-charging module, an FCA station, and an FCA system card.

4. The method of claim 1, wherein said step of providing and said step of offering are performed, at least in part, remotely on at least one portal selected from the group consisting of: an FCA portal, an ad portal, and a billing portal.

5. The method of claim 1, wherein said at least one billing option is selected from the group consisting of: a free fast-charging option during said step of broadcasting, a paid fast-charging option during said step of broadcasting, a paid fast-charging option during exemption from said step of broadcasting, and a regular-charging option for an allotted charging duration during said step of broadcasting, an online payment, a direct payment, a credit card payment, a third-party payment, an installment payment, and a prepaid FCA account debit.

6. The method of claim 1, wherein said advertising selection is based on at least one criterion selected from the group consisting of: an advertiser purchase, a user profile, user-specific usage-data from data-analytics portals, a geographic location of said FCA device, a business location of said FCA device, an FCA-device owner preference, a user-specific location-data history, weather data, an FCA user-preference profile, a category selection, and a selection group.

7. The method of claim 1, wherein said step of broadcasting is performed on at least one device selected from the group consisting of: said mobile device, said FCA device, a secondary display device, a secondary audio component.

8. The method of claim 1, wherein said step of broadcasting is performed by at least one operation selected from the group consisting of: transmitting said ad via a direct or indirect network download, delivering said ad from said FCA device, and retrieving said ad from a pre-cached storage location.

9. The method of claim 1, the method further comprising the step of:
(d) prior to said step of activating, securing all operations and all data associated with said FCA device.

10. The method of claim 1, the method further comprising the step of:
(d) prior to said step of broadcasting, checking for at least one ad update.

11. A fast-charging advertising (FCA) device for advertising during fast-charging of mobile devices, the FCA device comprising:
(a) a CPU for performing computational operations;
(b) a memory module for storing data;
(c) a connectivity module for operationally connecting to a network via a communication capability;
(d) a billing module configured for providing at least one billing option for a billing selection;
(e) an advertising module configured for offering at least one advertising option for an advertising selection; and
(f) an interface module configured for:
(i) upon engagement of a mobile device with the FCA device, operationally connecting with said mobile device in order to determine whether said mobile device is enabled for fast-charging;
(ii) interfacing with a fast-charging module configured to provide fast-charging capability to an enabled mobile device; and
(iii) upon determining said mobile device is enabled for fast-charging, activating an FCA capability, wherein said FCA capability is configured for:
(A) upon acceptance of said billing selection and said advertising selection, initiating fast-charging of said mobile device via said fast-charging module; and
(B) upon acceptance of said billing selection and said advertising selection, broadcasting an ad during said fast-charging.

12. The FCA device of claim 11, wherein said mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

13. The FCA device of claim 11, wherein said CPU, said memory module, said connectivity module, said billing module, said advertising module, and said interface module are embodied, at least in part, in at least one device selected from the group consisting of: said fast-charging module, an FCA station, and an FCA system card.

14. The FCA device of claim 11, wherein said providing and said offering are performed, at least in part, remotely on at least one portal selected from the group consisting of: an FCA portal, an ad portal, and a billing portal.

15. The FCA device of claim 11, wherein said at least one billing option is selected from the group consisting of: a free fast-charging option during said broadcasting, a paid fast-charging option during said broadcasting, a paid fast-charging option during exemption from said broadcasting, and a regular-charging option for an allotted charging duration during said broadcasting, an online payment, a direct payment, a credit card payment, a third-party payment, an installment payment, and a prepaid FCA account debit.

16. The FCA device of claim 11, wherein said advertising selection is based on at least one criterion selected from the group consisting of: an advertiser purchase, a user profile, user-specific usage-data from data-analytics portals, a geographic location of said FCA device, a business location of said FCA device, an FCA-device owner preference, a user-specific location-data history, weather data, an FCA user-preference profile, a category selection, and a selection group.

17. The FCA device of claim 11, wherein said broadcasting is performed on at least one device selected from the group consisting of: said mobile device, the FCA device, a secondary display device, a secondary audio component.

18. The FCA device of claim 11, wherein said broadcasting is performed by at least one operation selected from the group consisting of: transmitting said ad via a direct or indirect network download, delivering said ad from said FCA device, and retrieving said ad from a pre-cached storage location.

19. The FCA device of claim 11, the FCA device further comprising:
(g) a security module configured for securing all operations and all data associated with the FCA device.

20. The FCA device of claim 11, wherein said FCA capability is further configured for:
(C) prior to said broadcasting, checking for at least one ad update.

21. The FCA device of claim 11, wherein said billing module, said advertising module, and said interface module are embodied, at least in part, in said memory module.

22. A method for doing business, the method comprising the steps of:
(a) configuring a fast-charging advertising (FCA) device for:
(i) upon engagement of a mobile device with, operationally connecting with said mobile device in order to determine whether said mobile device is enabled for fast-charging;
(ii) interfacing with a fast-charging module configured to provide fast-charging capability to an enabled mobile device; and
(iii) upon determining said mobile device is enabled for fast-charging, activating an FCA capability, wherein said FCA capability includes:
(A) providing at least one billing option for a billing selection;
(B) giving at least one advertising option for an advertising selection; and
(C) upon acceptance of said billing selection and said advertising selection:
(I) initiating fast-charging of said mobile device via said fast-charging module; and
(II) broadcasting an ad during said fast-charging; and
(b) offering said initiating for sale.

23. The method of claim 22, wherein said providing and said giving are performed, at least in part, remotely on at least one portal selected from the group consisting of: an FCA portal, an ad portal, and a billing portal.

24. The method of claim 22, wherein said at least one billing option is selected from the group consisting of: a free fast-charging option during said broadcasting, a paid fast-charging option during said broadcasting, a paid fast-charging option during exemption from said broadcasting, and a regular-charging option for an allotted charging duration during said broadcasting, an online payment, a direct payment, a credit card payment, a third-party payment, an installment payment, and a prepaid FCA account debit.

25. The method of claim 22, wherein said advertising selection is based on at least one criterion selected from the group consisting of: an advertiser purchase, a user profile, user-specific usage-data from data-analytics portals, a geographic location of said FCA device, a business location of said FCA device, an FCA-device owner preference, a user-specific location-data history, weather data, an FCA user-preference profile, a category selection, and a selection group.

26. A method for doing business, the method comprising the steps of:
(a) configuring a fast-charging advertising (FCA) device for:
(i) upon engagement of a mobile device with, operationally connecting with said mobile device in order to determine whether said mobile device is enabled for fast-charging;
(ii) interfacing with a fast-charging module configured to provide fast-charging capability to an enabled mobile device; and
(iii) upon determining said mobile device is enabled for fast-charging, activating an FCA capability, wherein said FCA capability includes:
(A) providing at least one billing option for a billing selection;
(B) giving at least one advertising option for an advertising selection; and
(C) upon acceptance of said billing selection and said advertising selection:
(I) initiating fast-charging of said mobile device via said fast-charging module; and
(II) broadcasting an ad during said fast-charging; and
(b) offering said broadcasting for sale.

27. The method of claim 26, wherein said providing and said giving are performed, at least in part, remotely on at least one portal selected from the group consisting of: an FCA portal, an ad portal, and a billing portal.

28. The method of claim 26, wherein said at least one billing option is selected from the group consisting of: a free fast-charging option during said broadcasting, a paid fast-charging option during said broadcasting, a paid fast-charging option during exemption from said broadcasting, and a regular-charging option for an allotted charging duration during said broadcasting, an online payment, a direct payment, a credit card payment, a third-party payment, an installment payment, and a prepaid FCA account debit.

29. The method of claim 26, wherein said advertising selection is based on at least one criterion selected from the group consisting of: an advertiser purchase, a user profile, user-specific usage-data from data-analytics portals, a geographic location of said FCA device, a business location of said FCA device, an FCA-device owner preference, a user-specific location-data history, weather data, an FCA user-preference profile, a category selection, and a selection group.

30. A non-transitory computer-readable medium, having computer-readable code embodied on the non-transitory computer-readable medium, the computer-readable code having program code for advertising during fast-charging of mobile devices, the computer-readable code comprising:
(a) program code for, upon engagement of a mobile device with a fast-charging advertising (FCA) device, operationally connecting with said mobile device in order to determine whether said mobile device is enabled for fast-charging;
(b) program code for interfacing with a fast-charging module configured to provide fast-charging capability to an enabled mobile device; and
(c) program code for, upon determining said mobile device is enabled for fast-charging, activating an FCA capability, wherein said FCA capability includes:
(i) program code for, providing at least one billing option for a billing selection;
(ii) program code for, offering at least one advertising option for an advertising selection; and
(iii) program code for, upon acceptance of said billing selection and said advertising selection:
(A) initiating fast-charging of said mobile device via said fast-charging module; and
(B) broadcasting an ad during said fast-charging.

31. The computer-readable medium of claim 30, wherein said mobile device is at least one device selected from the group consisting of: a smartphone, a tablet computer, a hand-held electronic device, a wearable electronic device, a peripheral device having an integral battery, a slave battery, an external flash component, an external camera component, an external audio component, and an external display component.

32. The computer-readable medium of claim 30, wherein said FCA device is embodied in at least one device selected from the group consisting of: said fast-charging module, an FCA station, and an FCA system card.

33. The computer-readable medium of claim 30, wherein said providing and said offering are performed, at least in part, remotely on at least one portal selected from the group consisting of: an FCA portal, an ad portal, and a billing portal.

34. The computer-readable medium of claim 30, wherein said at least one billing option is selected from the group consisting of: a free fast-charging option during said broadcasting, a paid fast-charging option during said broadcasting, a paid fast-charging option during exemption from said broadcasting, and a regular-charging option for an allotted charging duration during said broadcasting, an online payment, a direct payment, a credit card payment, a third-party payment, an installment payment, and a prepaid FCA account debit.

35. The computer-readable medium of claim 30, wherein said advertising selection is based on at least one criterion selected from the group consisting of: an advertiser purchase, a user profile, user-specific usage-data from data-analytics portals, a geographic location of said FCA device, a business location of said FCA device, an FCA-device owner preference, a user-specific location-data history, weather data, an FCA user-preference profile, a category selection, and a selection group.

36. The computer-readable medium of claim 30, wherein said broadcasting is performed on at least one device selected from the group consisting of: said mobile device, said FCA device, a secondary display device, a secondary audio component.

37. The computer-readable medium of claim 30, wherein said broadcasting is performed by at least one operation selected from the group consisting of: transmitting said ad via a direct or indirect network download, delivering said ad from said FCA device, and retrieving said ad from a pre-cached storage location.

38. The computer-readable medium of claim 30, the computer-readable code comprising further comprising:
(d) prior to said activating, securing all operations and all data associated with said FCA device.

39. The computer-readable medium of claim 30, the computer-readable code comprising further comprising:
(d) program code for, prior to said broadcasting, checking for at least one ad update.
